(19) United States
(12) Patent Application Publication
(10) Pub. No.: US 2014/0036126 A1
(43) Pub. Date: Feb. 6, 2014

(54) DIGITAL VIDEO CAMERA WITH A PROJECTOR

(71) Applicants: Martin Barry Abrams, Kings Point, NY (US); Joel Rosenzweig, Mincola, NY (US)

(72) Inventors: Martin Barry Abrams, Kings Point, NY (US); Joel Rosenzweig, Mincola, NY (US)

(21) Appl. No.: 13/729,039

(22) Filed: Dec. 28, 2012

Related U.S. Application Data
(60) Provisional application No. 61/679,560, filed on Aug. 3, 2012.

(51) Int. Cl. H04N 5/232

(52) U.S. Cl. CPC H04N 5/23293
USPC 348/333.1

(57) ABSTRACT

The invention is a digital video camera and projector that is suitable for use by children or young adults, does not require the user to engage a mechanical switching of the lenses from video camera mode to Projection mode.

### BACKGROUND OF THE INVENTION

The current invention relates to video cameras and projector devices. Specifically, it relates to a video camera, designed to be used by a child or a young adult, which captures digital videos and projects those videos.

Providing an easy operate, sturdy, and high quality digital video camera is an important part of teaching children the value of photography. The combination of both a projector and a digital video camera allows the user to take videos and immediately share them with a group of people. The addition of the projection system allows children to share video-s with each other in a cooperative, fun, entertaining, and mutually beneficial manner.

Although projectors have been combined with cameras in the past, these devices, which have complex lens systems that include a mechanical switching of the lenses from camera mode to Projection mode, are not suitable for use by children or young adults. Additionally, the prior camera and projector combination devices do not have a placement and orientation of the lenses that is simplified and does not require a miniature and very expensive lens system.

Thus, what is needed is a combination digital video camera and projector that: is designed to be simple to use by children or young adults; does not require the user to engage a mechanical switching of the lenses from video camera mode to Projection mode.

### SUMMARY OF THE INVENTION

To minimize the limitations in the prior art, and to minimize other limitations that will become apparent upon reading and understanding the present specification, the present invention discloses a new and useful digital video camera and projector device, which is designed to be used by children or young adults, and does not require the user to engage a mechanical switching of the lenses from video camera mode to Projection mode.

One embodiment of the invention is a digital video camera and projector device comprising: a digital video camera; and a projector. The digital video camera and projector device may further include a projection control panel, and a video camera operation button. Preferably, the device also has a projector focus wheel, a flash, a flash operation button, a viewing screen. Preferably the projection control panel includes a power button, one or more scrolling buttons, a delete button, and a project button, which turns on and off the projector. The projector has a plurality of lenses, a projector liquid crystal display, and a light emitting diode. Preferably the plurality of lenses are positioned as shown in FIGS. 2 and 13 such that a brightness and a sharpness of a projected video are optimized.

Another embodiment of the invention is a digital video camera and projector device that designed to be used by a child.

Another embodiment of the invention is a digital video camera and projector device that designed to be used by a young adult or teenager.

The digital video camera and projector device, preferably, does not use a mechanical lens switching device to switch between the video camera and projector as previous devices have done. Instead, the video captured by the video camera is electronically sent to a liquid crystal display (“LCD”) thin film transistor (“TFT”) screen wherein a bright light emitting diode (“LED”) is positioned behind the screen to project the video. Because the lenses of the projector are preferably stationary within the device, the device preferably looks like a single-lens reflex video camera, with a long nose. The long nose provides a convenient shape and place in which to position the projection lenses. Preferably the video camera component is positioned on top of the projector. The projector preferably has an automatic shutoff to avoid burning out the LED or overheating the projector.

It is an object of the invention to provide a video camera and projector device that is suitable for teens, young adults, or children.

### BRIEF DESCRIPTION OF THE DRAWINGS

FIG. 1 is an illustration of an exploded view of one embodiment of the video camera and projector device.

FIG. 2 is an illustration of various six plan views of one embodiment of the video camera and projector device.

FIG. 3 is a back view of one embodiment of the video camera and projector device.

FIG. 4 is a perspective view of one embodiment of the video camera and projector device.

FIG. 5 is a side view of one embodiment of the video camera and projector device.

FIG. 6 is a front view of one embodiment of the video camera and projector device.

FIG. 7 is a close-up side view of one embodiment of the video camera and projector device.

FIG. 8 is a back plan view of one embodiment of the video camera and projector device.

FIG. 9 is a top view of one embodiment of the video camera and projector device.

FIG. 10 is a bottom view of one embodiment of the video camera and projector device.

FIG. 11 is a front perspective view of one embodiment of the video camera and projector device.

FIG. 12 is a close-up perspective view of one embodiment of the video camera and projector device.

FIG. 13 is an illustration of six plan views of a second embodiment of the video camera and projector device.

FIG. 14 is a perspective view of a second embodiment of the video camera and projector device.

FIG. 15 is a front view of a second embodiment of the video camera and projector device.

FIG. 16 is a side view of a second embodiment of the video camera and projector device.

FIG. 17 is a back view of a second embodiment of the video camera and projector device.

FIG. 18 is a side view of a second embodiment of the video camera and projector device.

FIG. 19 is a close-up perspective view of a second embodiment of the video camera and projector device.

FIG. 20 is a top view of a second embodiment of the video camera and projector device.

FIG. 21 is a bottom view of a second embodiment of the video camera and projector device.

### DETAILED DESCRIPTION OF THE INVENTION

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

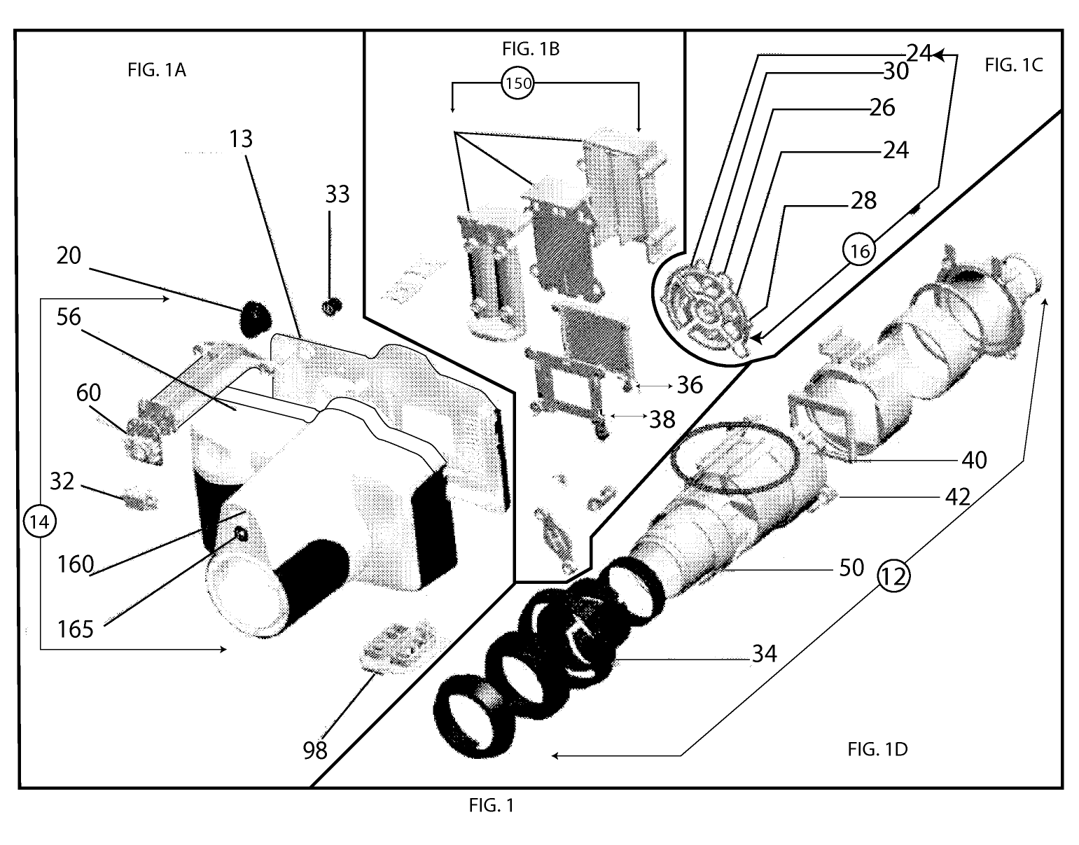

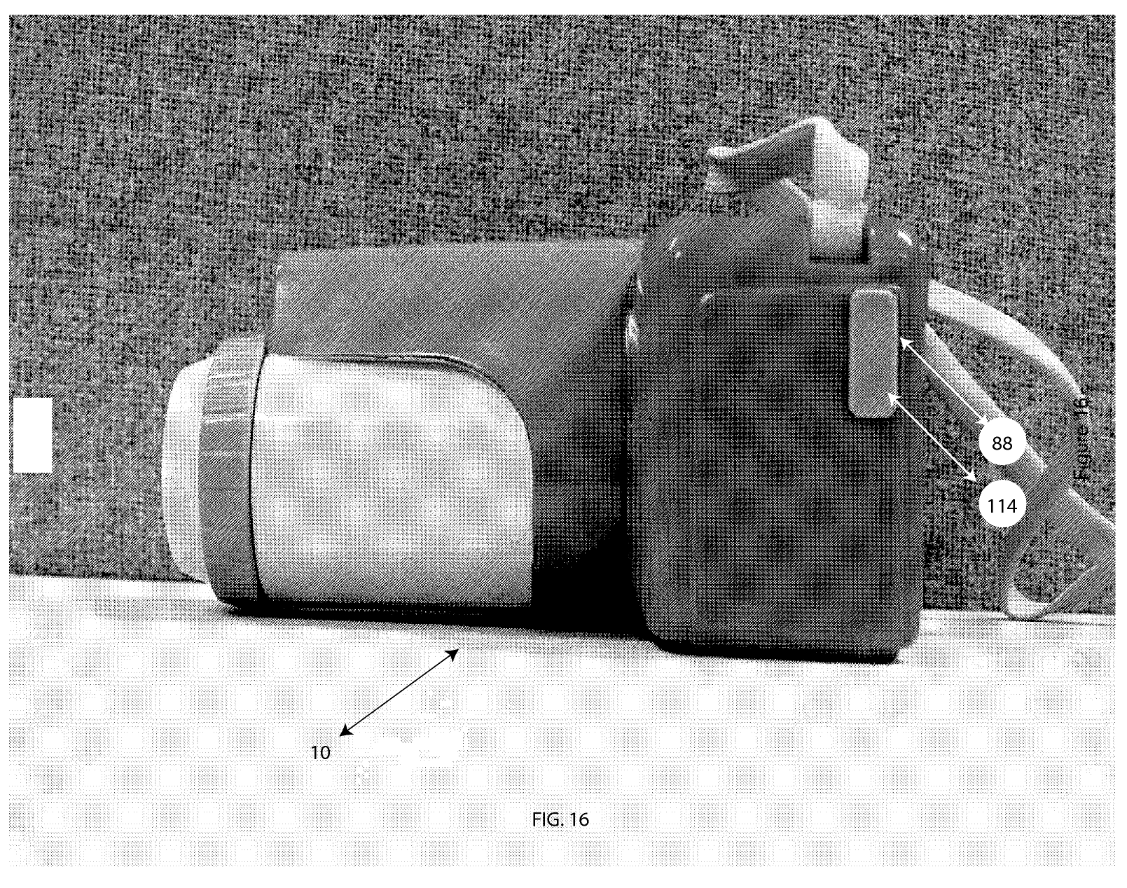

FIG. 1 is an illustration of an exploded view of one embodiment of the video camera and projector device 10. As shown in FIG. 1, the device preferably includes a projector 12 and a video camera 14 with back cover 13. The projector and video camera device 10 preferably includes: a shutter button (video camera unit operation button) 20; two scroll buttons 24, a power button 26; a delete or trash button 28; a project button 30, a flash 32, a focus wheel 34 (See FIG. 16.), a view screen (preferably LCD) 36, a view screen cover 38, a projector LCD 40, an LCD holder 42, an LED 46, a light tube 50, a power source 52 (preferably battery); a shell 56; and a projector indicator light.

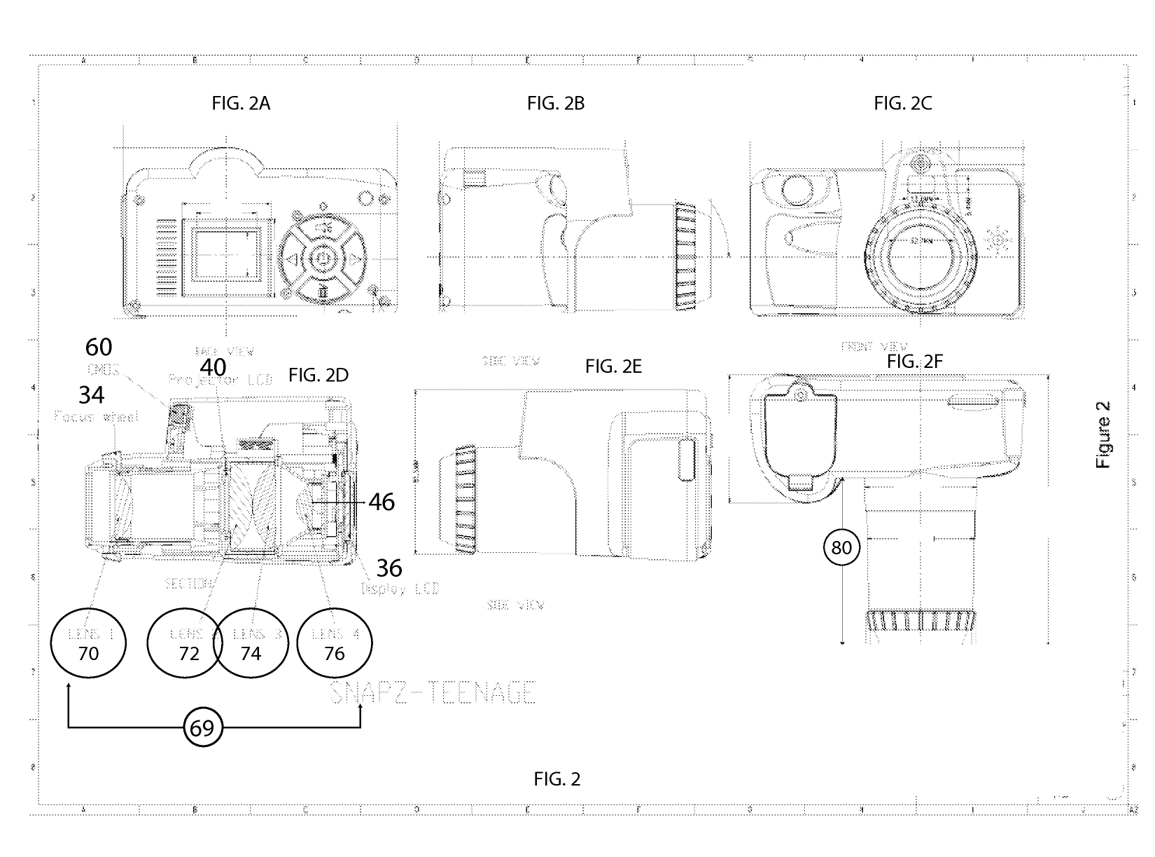

FIG. 2 is an illustration of various six plan views of one embodiment of the video camera and projector device 10. As shown in FIG. 2, the device preferably has a back, a left side, a front, a right side, top, and a bottom. FIG. 2 also shows how the projector lenses 69 are preferably arranged within the device and how the video camera 35 (also called video camera unit 35) is mounted within the shell 56 and on top of the projector 12. As shown in FIG. 2, lens 4 (76) is used to brighten the LED 40 that is positioned directly behind it. Lens 3 (74) is also used to increase brightness and the combination of lenses 2 (72) and 3 (70) are used to correct image distortion of the light going through to the Projector LCD 40. Lens 1 (70) is used as a moveable focus lens and is adjusted with the focus wheel 34. This positioning of the lenses provides for optimized brightness and sharpness of the image projected. FIG. 2 also shows how the shell 56 (also called housing 56) of the video camera is shaped with a long nose 80, similar in appearance to a single-lens reflex video camera. This long nose 80 provides a place to position the lenses appropriately.

FIG. 2 also shows how the video camera preferably includes a complementary metal-oxide-semiconductor (“CMOS”) image sensor 60, although any other digital sensor may be used, including a charge coupled device, without deviating from the scope of the invention. The video camera preferably captures video clips and still pictures. The device may also capture sound during recordation of the video clips.

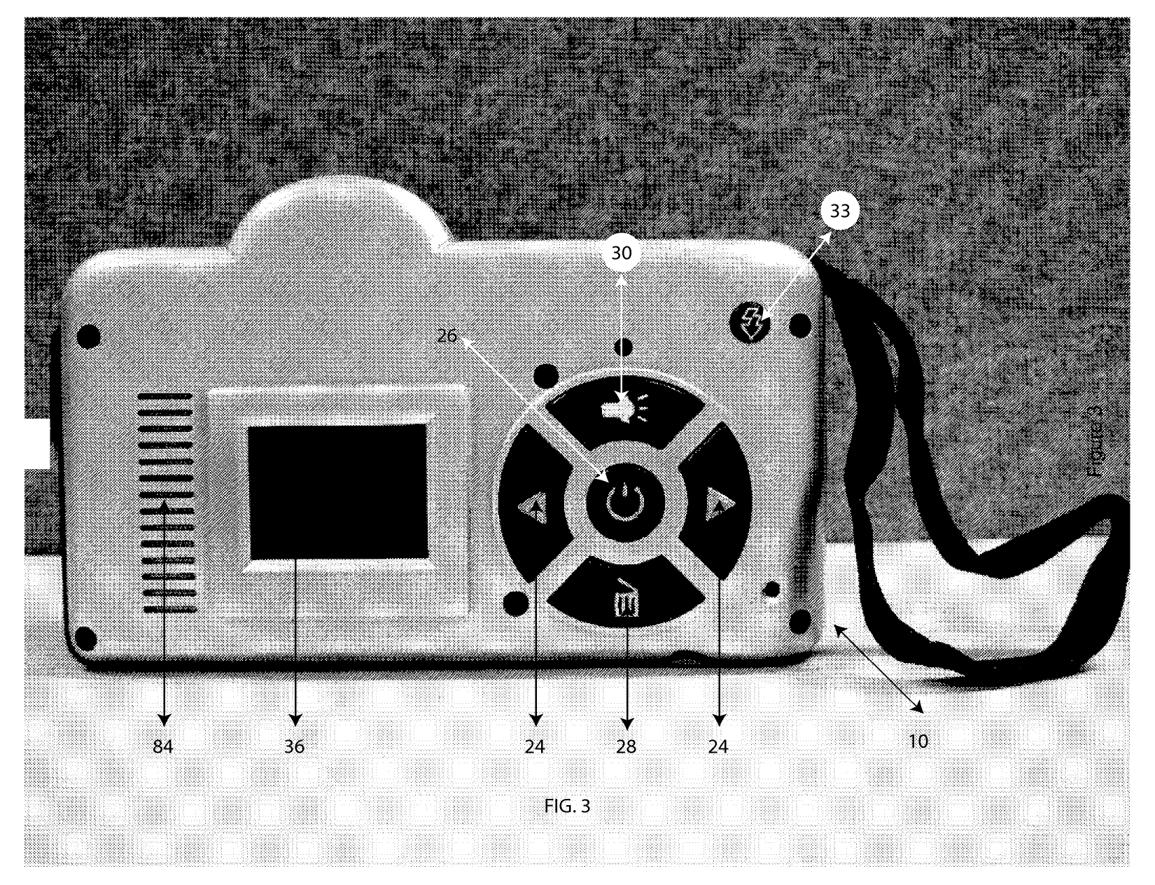

FIG. 3 is a back view of one embodiment of the video camera and projector device 10. FIG. 3 shows the flash button 33, the project button 30, the LCD view screen 36, the scroll buttons 24, the delete or trash button 28, and the on/off button 26. FIG. 3 also shows the projector vent 84 (See FIG. 16.), which helps keep the projector cool.

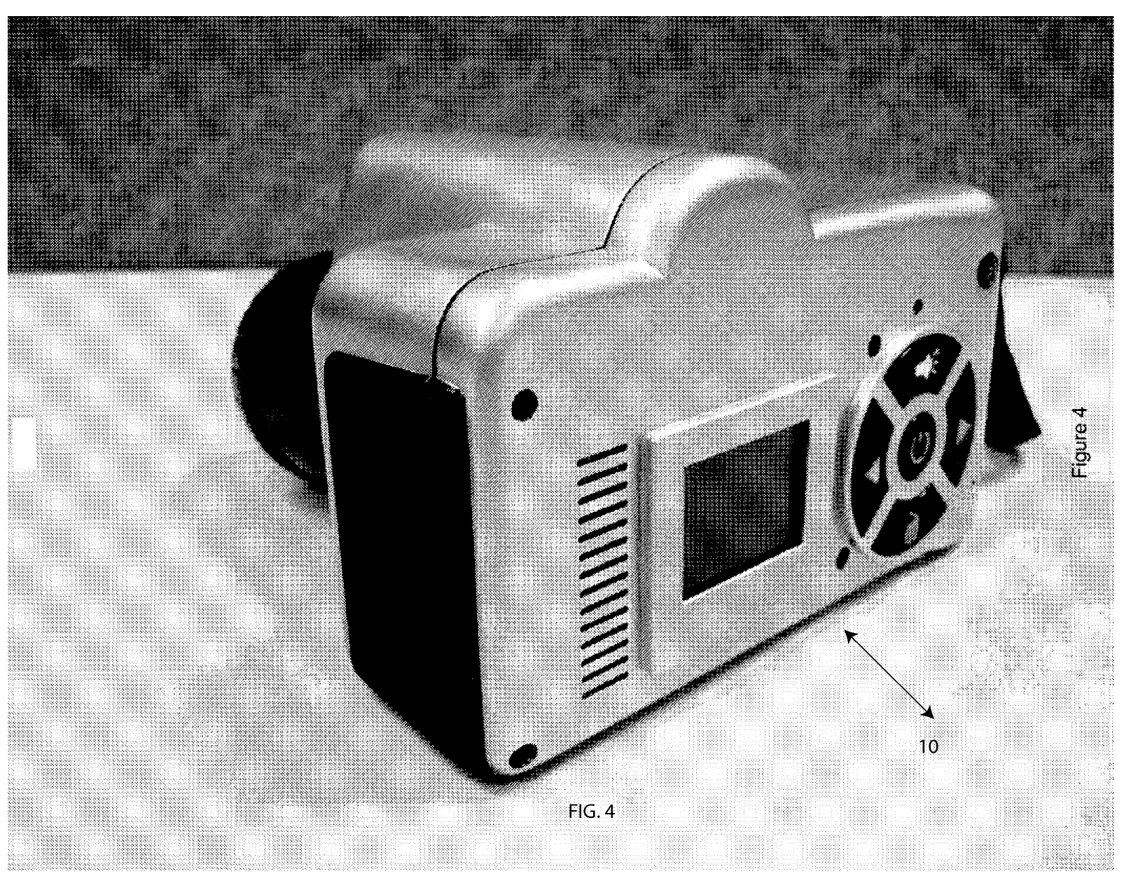

FIG. 4 is a perspective view of one embodiment of the video camera and projector device. FIG. 4 shows that the side of the device has a plug 114 that covers up a universal serial bus (“USB”) port 88. The USB port allows users to save, upload, and download videos and pictures to the device. (See FIG. 16.)

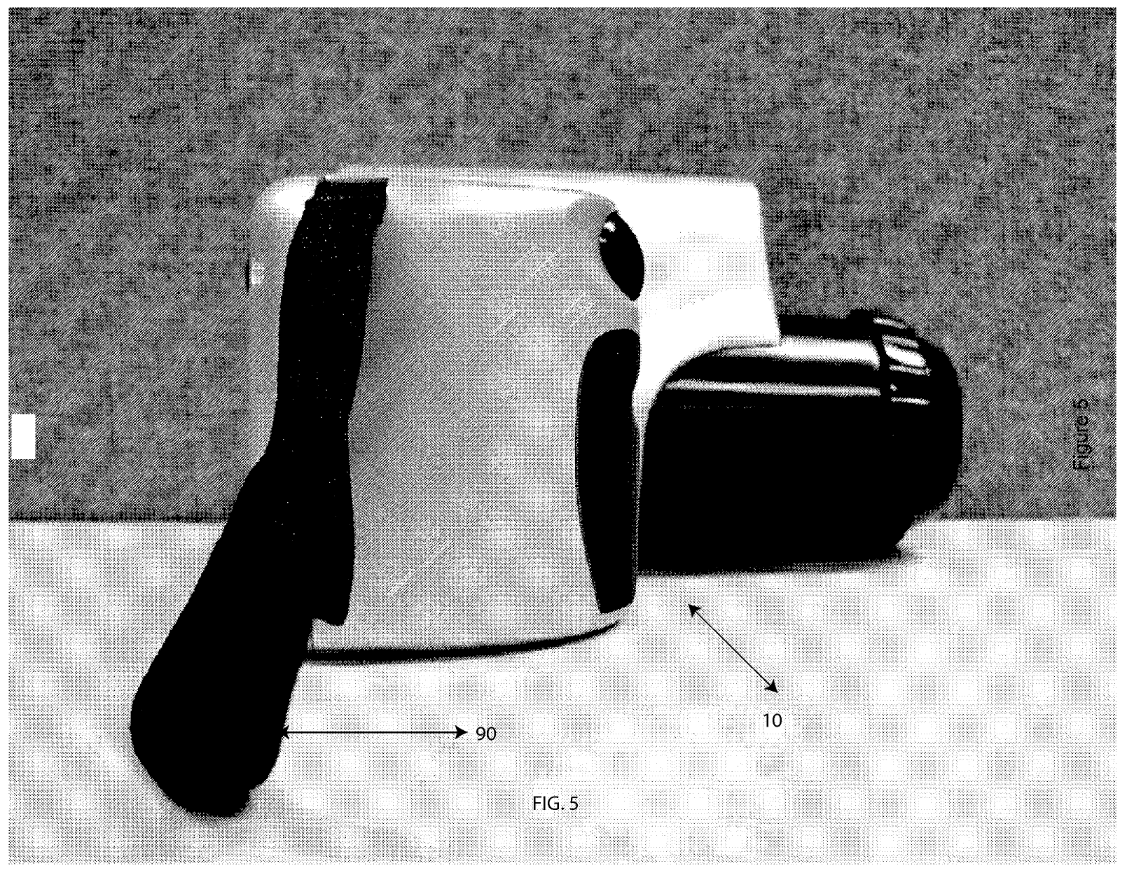

FIG. 5 is a side view of one embodiment of the video camera and projector device. FIG. 5 shows how the shutter button 20 is preferably positioned in the front of the video camera. FIG. 5 also shows how the video camera preferably has a strap 90. Although a flexible cloth strap 90 is shown, the device may use any cord, chain, connection device, or strap, made out of any material, without deviating from the scope of the invention.

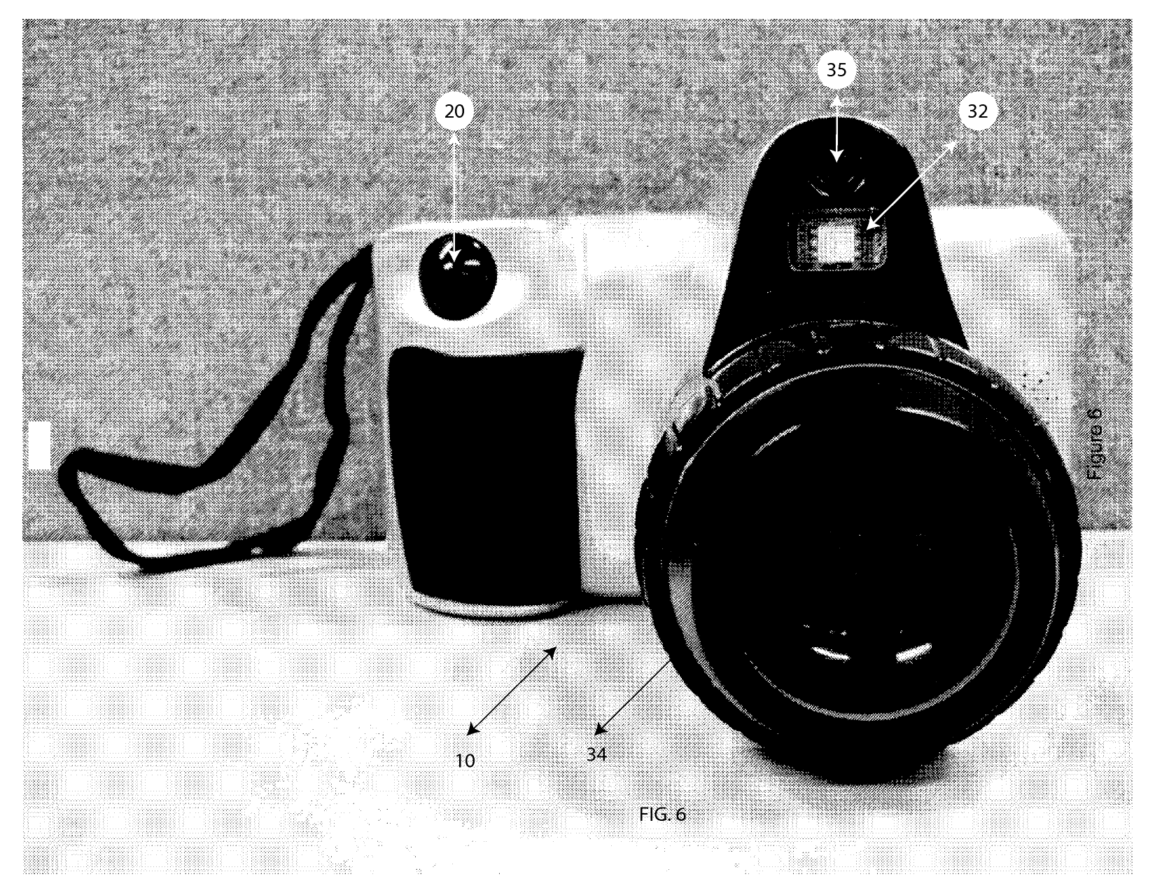

FIG. 6 is a front view of one embodiment of the video camera and projector device. FIG. 6 shows how the flash 32 is preferably positioned just under the video camera 35 and just over the projector 12. The focus wheel 34 is shown at the end of the nose 80. This allows users to adjust the focus of the projector.

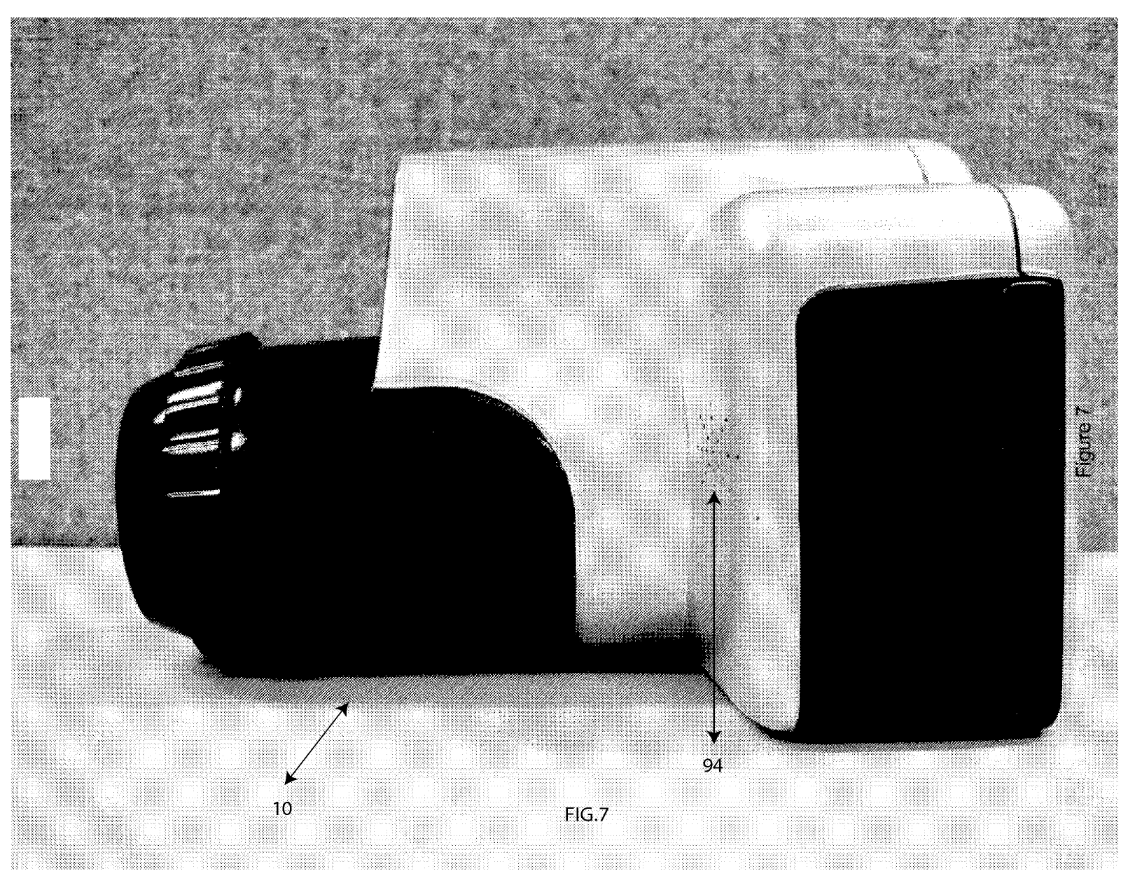

FIG. 7 is a close-up side view of one embodiment of the video camera and projector device 10. FIG. 7 shows that the device preferably has speaker holes 94 and a speaker behind not seen that allow the user play sound in the event that a video clip is being projected.

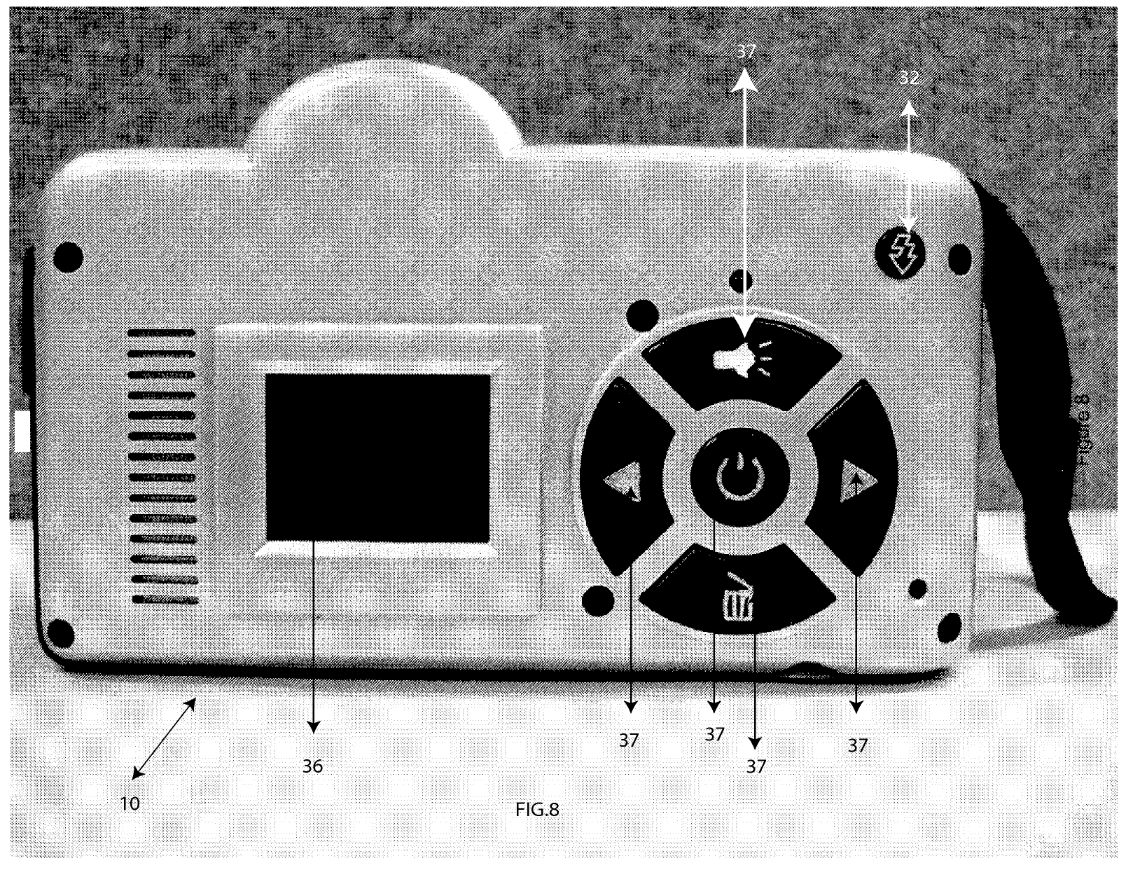

FIG. 8 is a back plan view of one embodiment of the video camera and projector device 10. FIG. 8 shows how the buttons preferably have picture 37 legends that inform the user what the button does. FIG. 8 also shows how the view screen 36 functions as the view finder for the video camera.

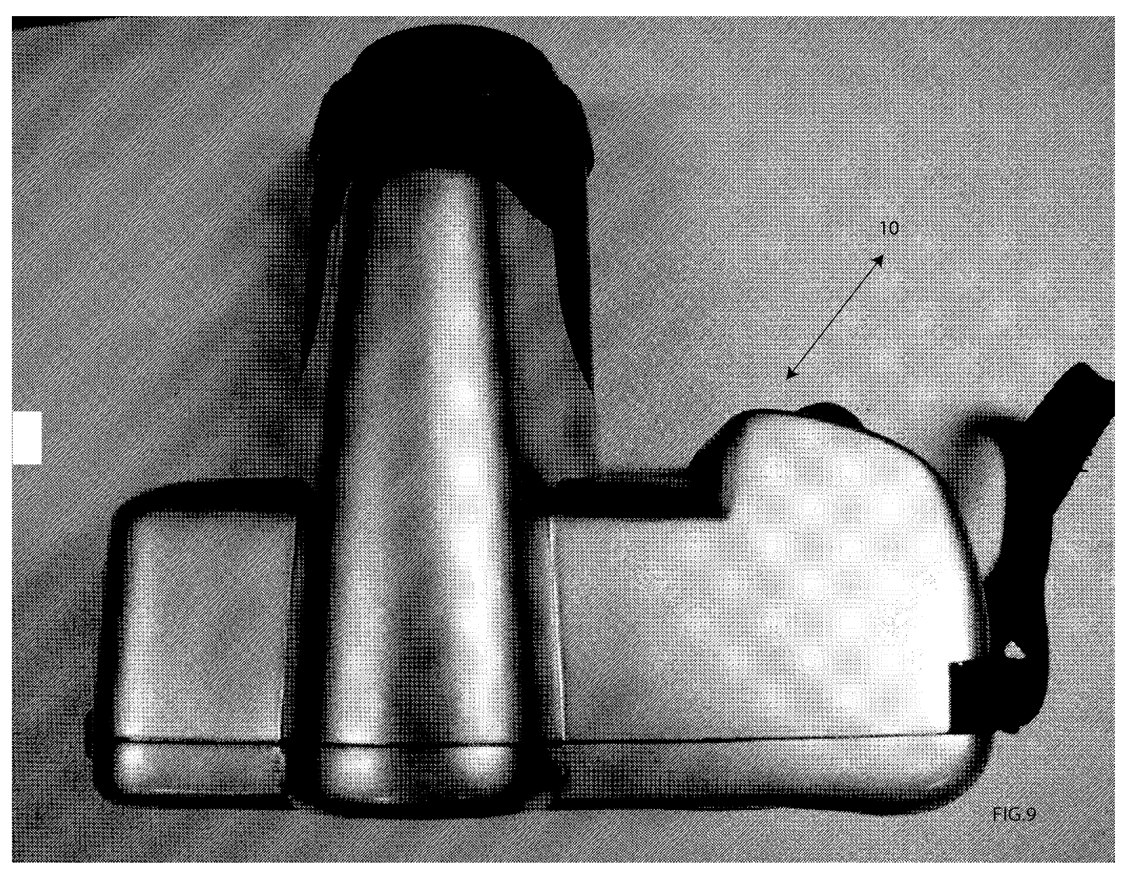

FIG. 9 is a top view of one embodiment of the video camera and projector device.

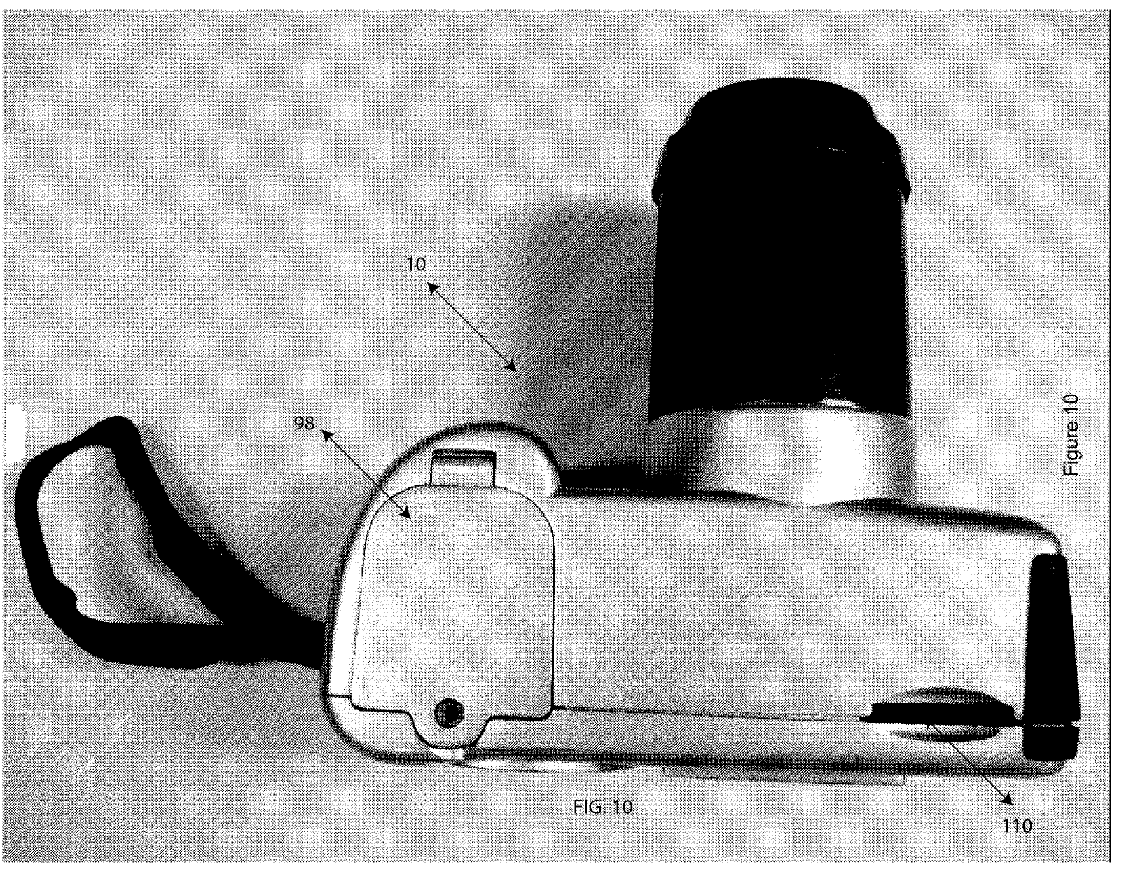

FIG. 10 is a bottom view of one embodiment of the video camera and projector device 10. FIG. 10 shows that the device preferably has a power unit that is accessible through a cover 98. Preferably the device is powered by batteries. FIG. 10 also shows that this embodiment of the device has a slot 110 that engages a memory card. This allows the user to upload and download videos and pictures to the device. The device is able to project videos and pictures saved on the video camera and videos and pictures saved on a memory card.

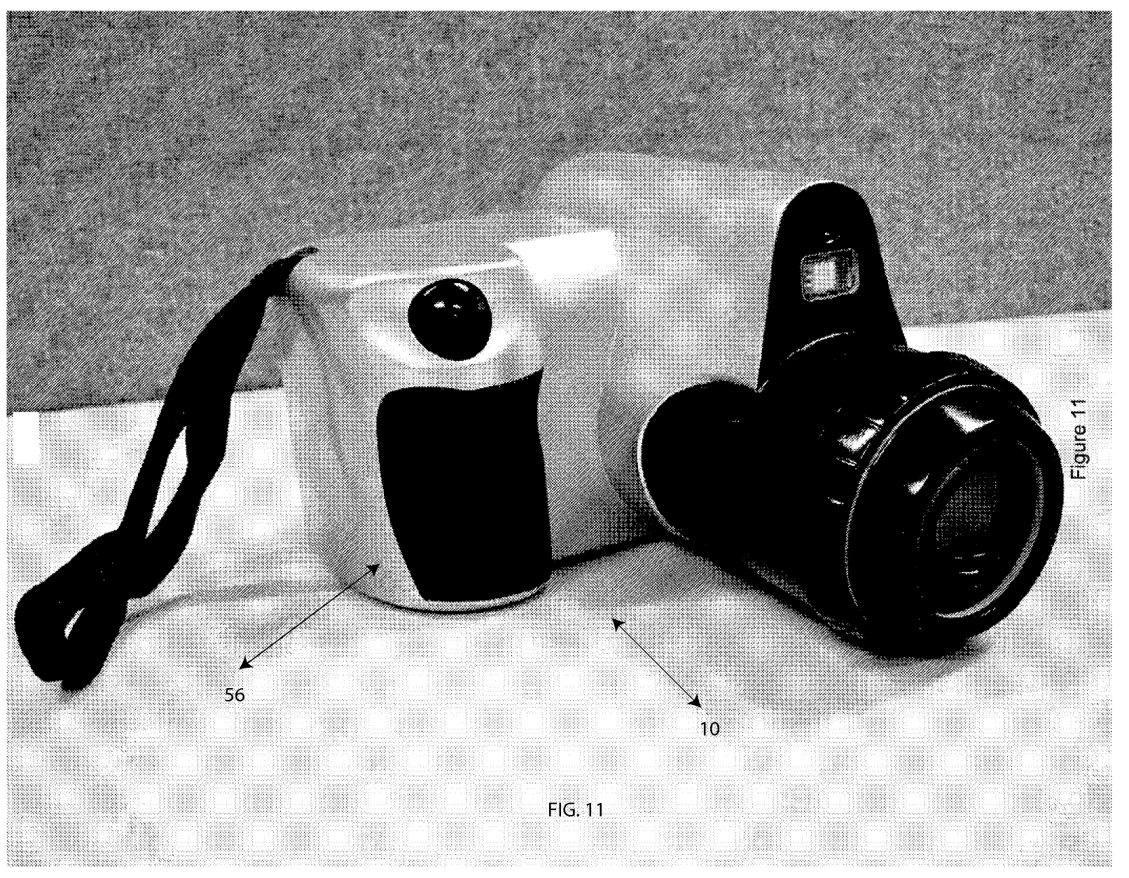

FIG. 11 is a front perspective view of one embodiment of the video camera and projector device. FIG. 11 shows how the device preferably has a strong shell 56 that is made of light weight, high impact plastic or metal. However, the device may be made from any material without deviating from the scope of the invention.

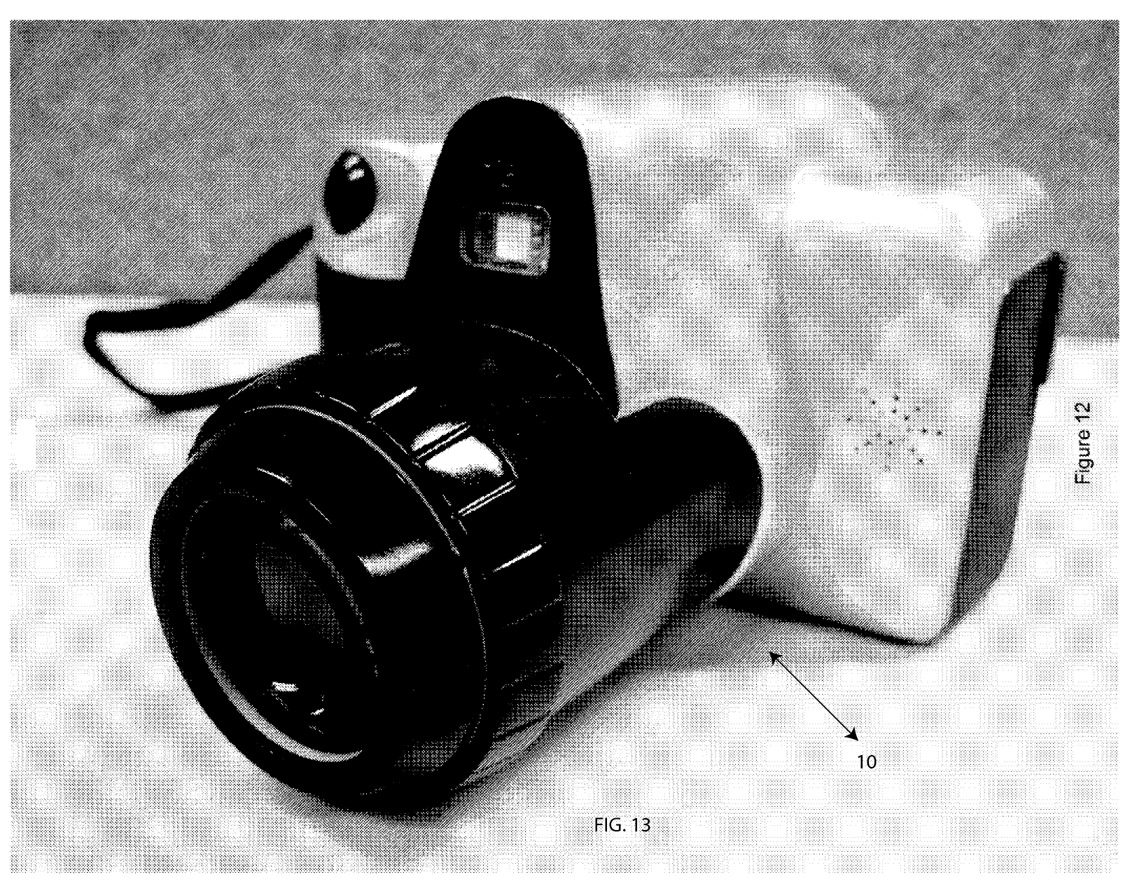

FIG. 12 is a close-up perspective view of one embodiment of the video camera and projector device.

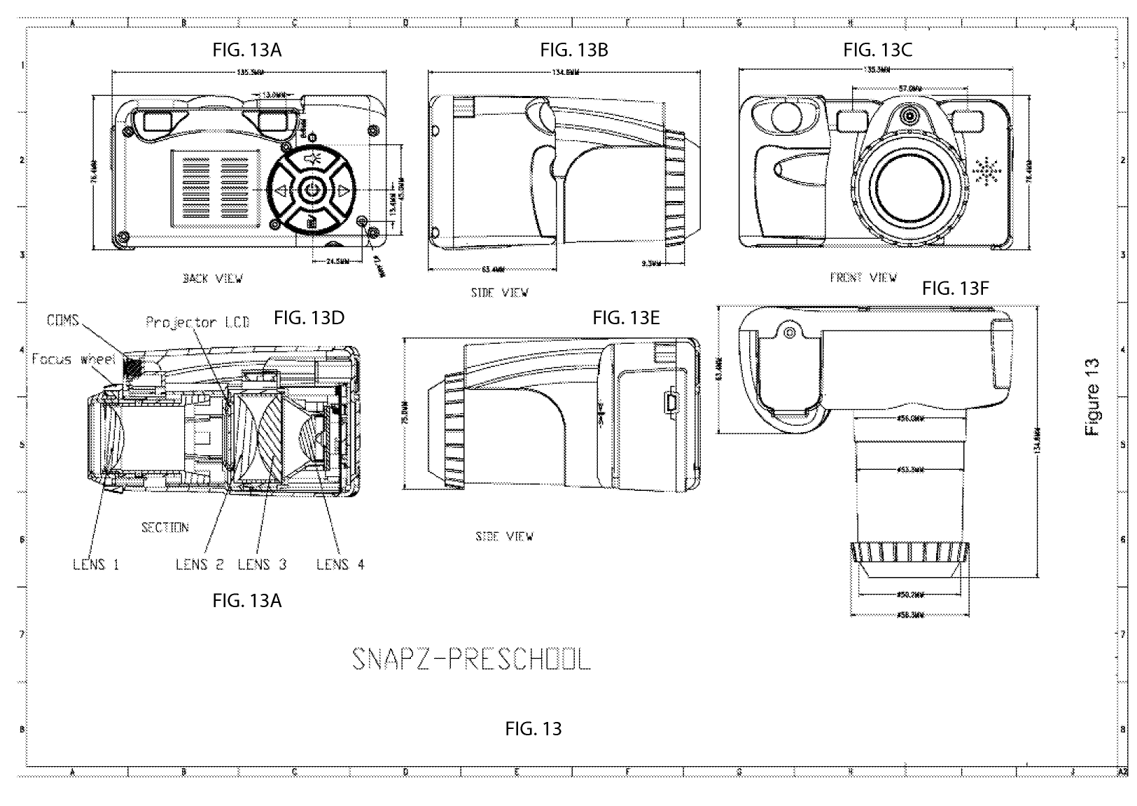

FIG. 13 is an illustration of six plan views of a second embodiment of the video camera and projector device. FIG. 13 shows a second embodiment of the invention, which does not have a view screen in the back of the video camera and which does not have a flash. As shown in FIG. 13, the device preferably has a back, a left side, a front, a right side and a bottom. FIG. 13 also shows how the projector lenses are preferably arranged within the device and how the video camera is mounted within the shell and on top of the projector. As shown in FIG. 13, lens 4 is used to brighten the LED that is positioned directly behind it. Lens 3 is also used to increase brightness and the combination of lenses 2 and 3 are used to correct image distortion of the light going through to the Projector LCD. Lens 1 is used as a moveable focus lens and is adjusted with the focus wheel. This positioning of the lenses provides for optimized brightness and sharpness of the image projected. FIG. 13 also shows how the shell of the video camera is shaped with a long nose, similar in appearance to a single-lens reflex video camera. This long nose provides a place to position the lenses appropriately.

FIG. 13 also shows how the video camera preferably includes a complementary metal-oxide-semiconductor (“CMOS”) image sensor 60, although any other digital sensor may be used, including a charge coupled device, without deviating from the scope of the invention. (see FIG. 2 for part numbers)

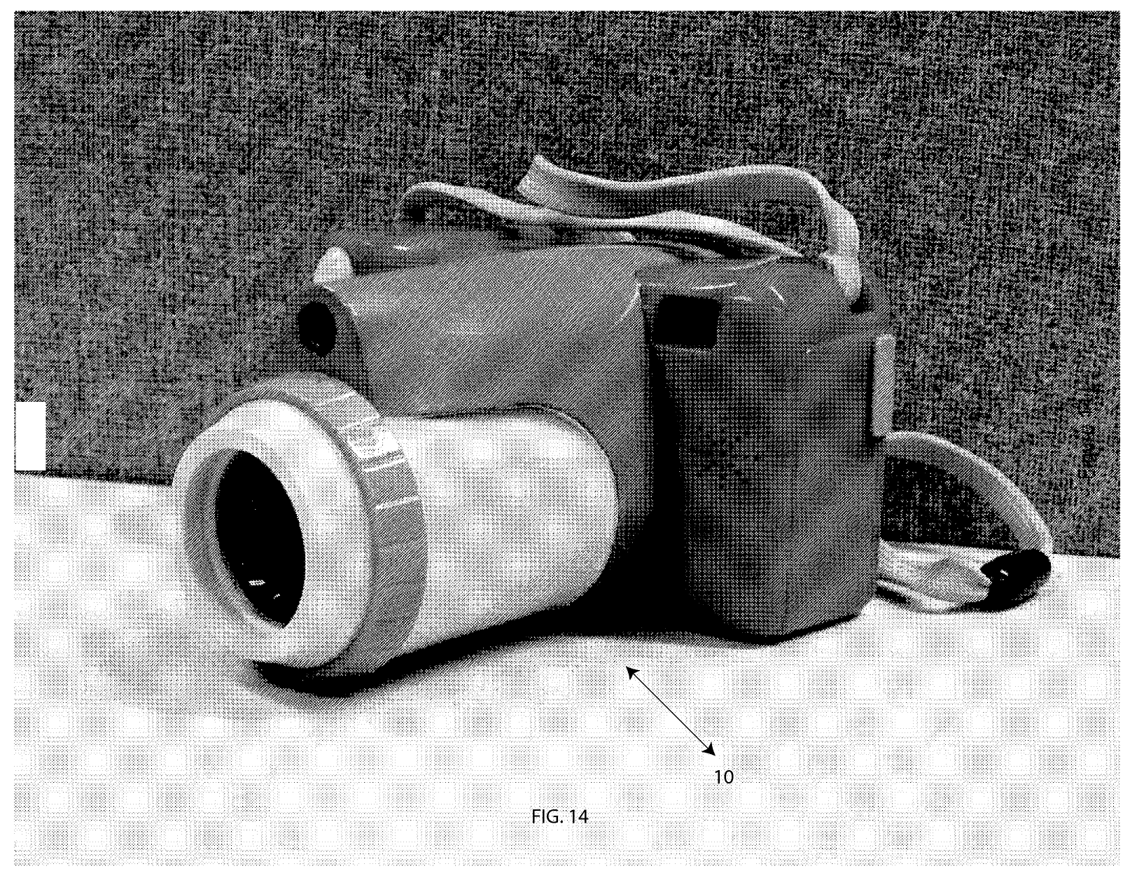

FIG. 14 is a perspective view of a second embodiment of the video camera and projector device.

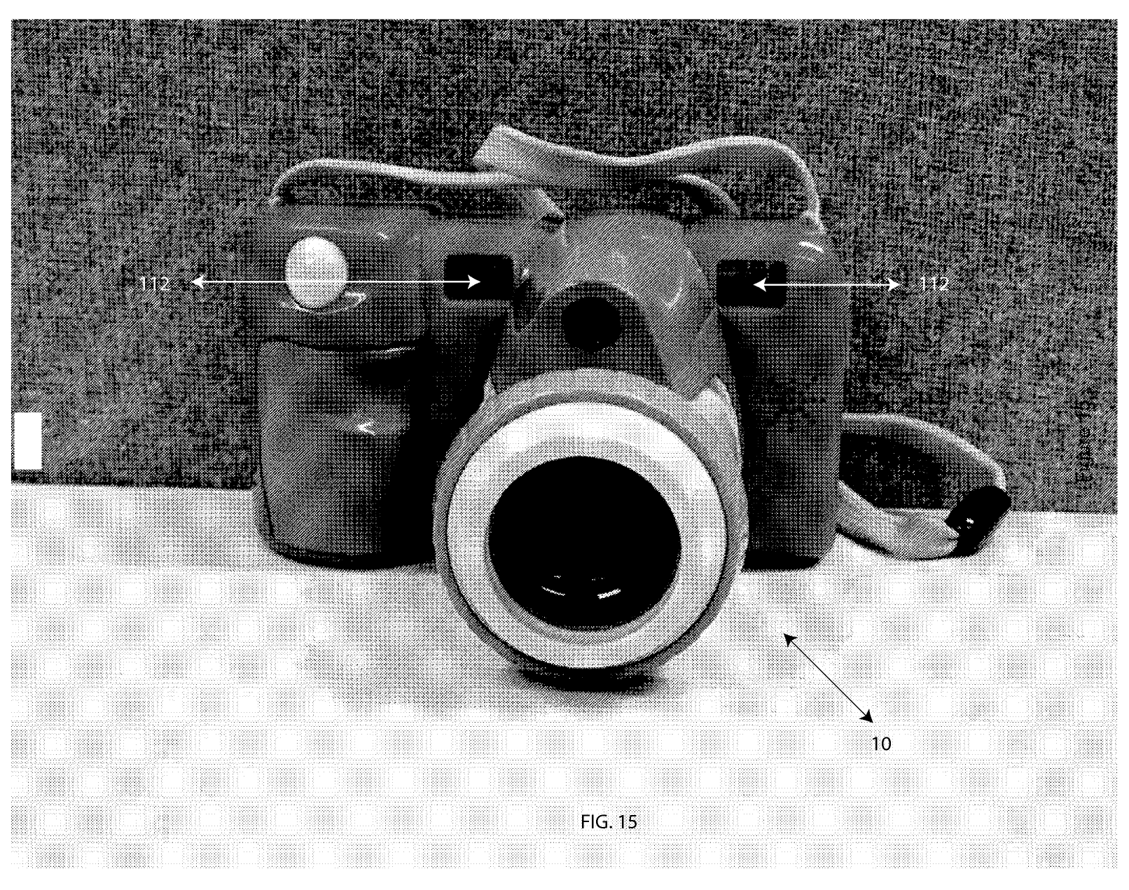

FIG. 15 is a front view of a second embodiment of the video camera and projector device. FIG. 15 shows that the device of a second embodiment preferably has two view finders 112 on the right and left side of the video camera and that the device does not have a flash.

FIG. 16 is a side view of a second embodiment of the video camera and projector device. FIG. 16 shows that the device preferably has a plug 114 that covers up a USB port 88. The USB port 88 allows users to save, upload, and download videos and pictures to the device.

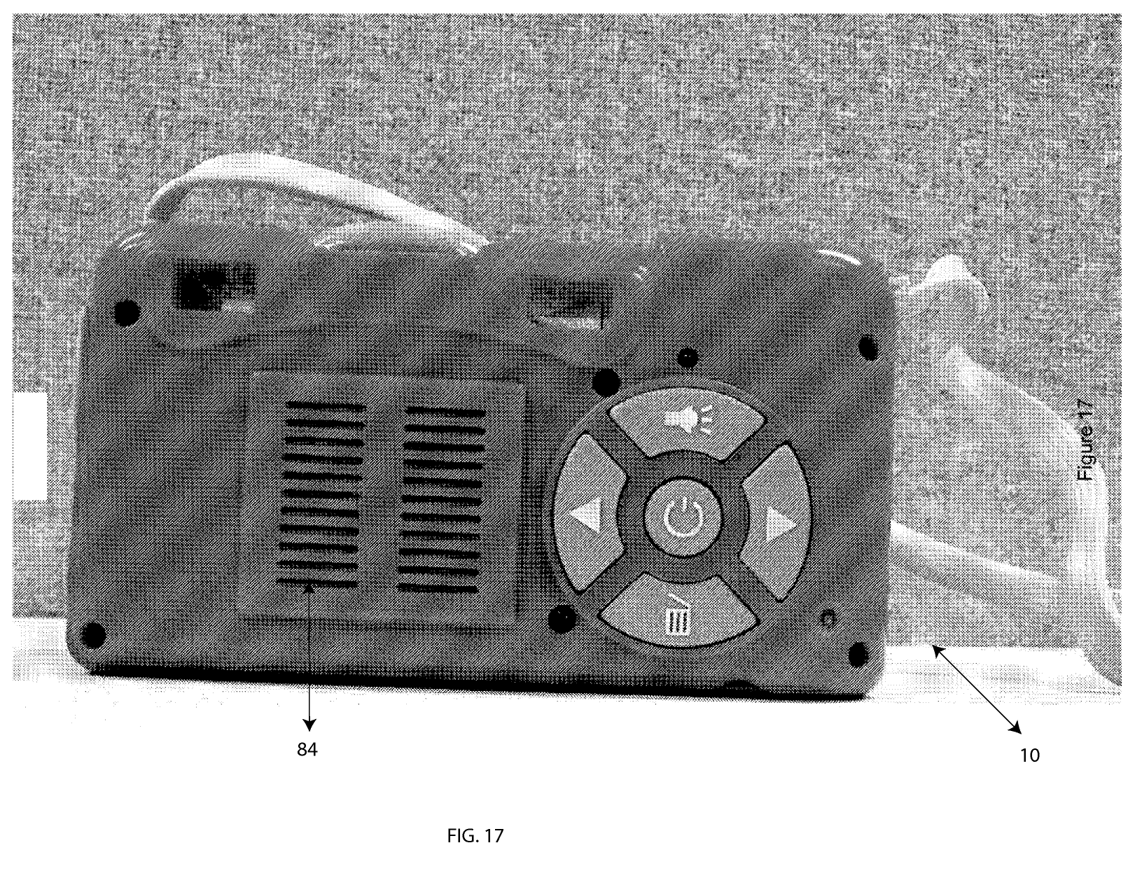

FIG. 17 is a back view of a second embodiment of the video camera and projector device. FIG. 17 shows that the device in this embodiment does not have a view screen or a flash button. In this embodiment the vent 84 is positioned directly behind the LED light 46 for optimal ventilation and cooling.

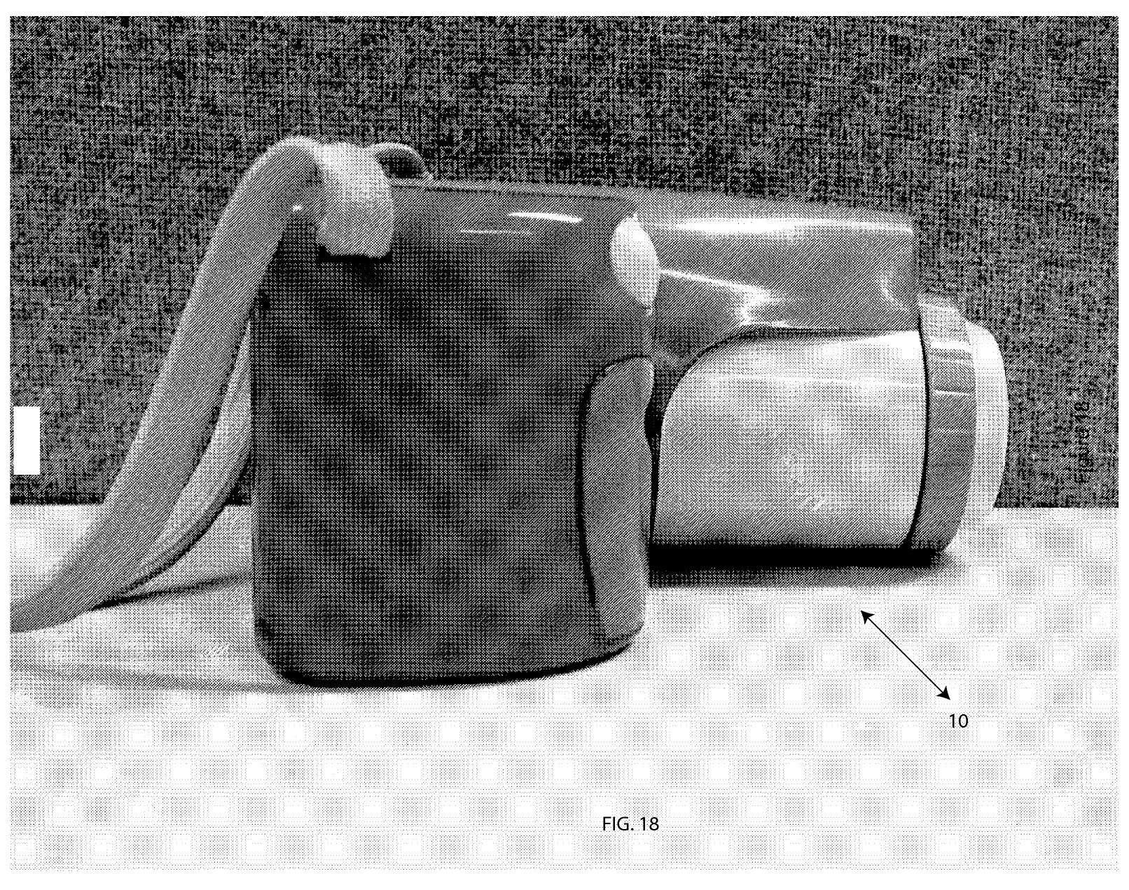

FIG. 18 is a side view of a second embodiment of the video camera and projector device.

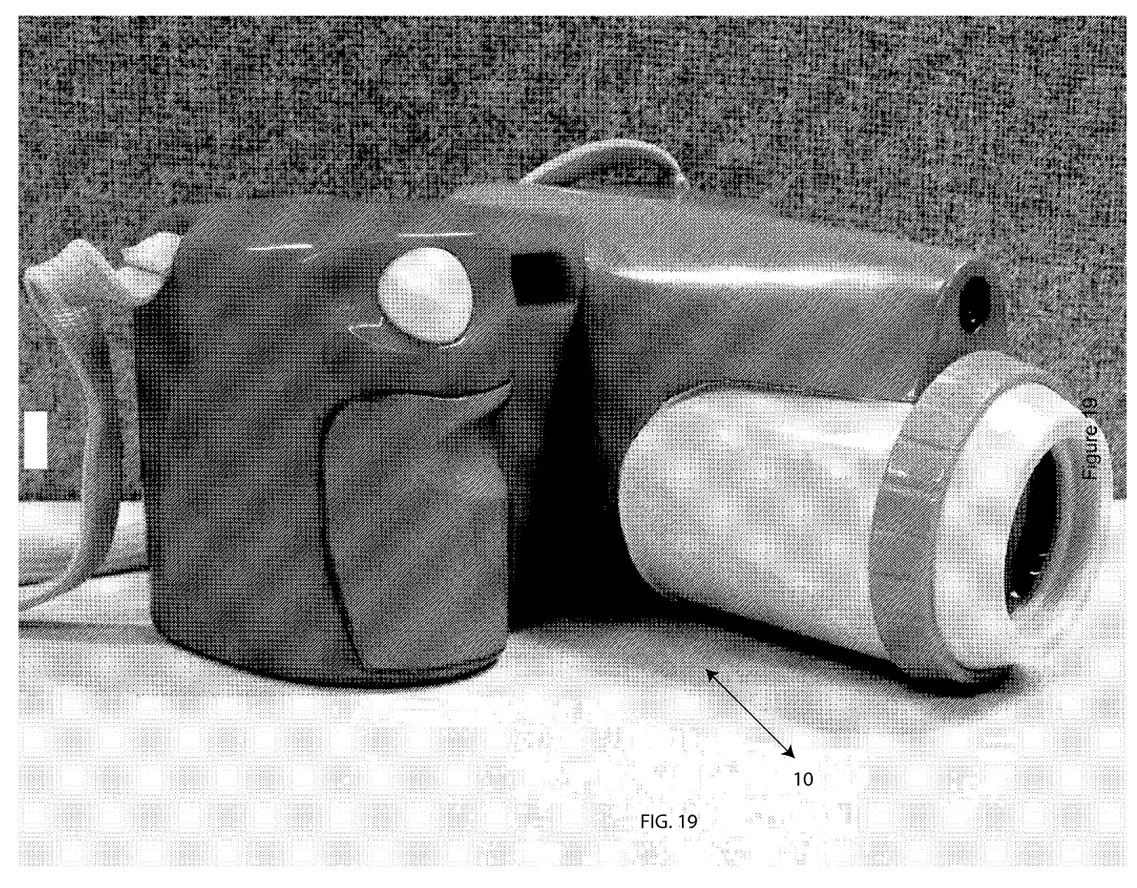

FIG. 19 is a close-up perspective view of a second embodiment of the video camera and projector device.

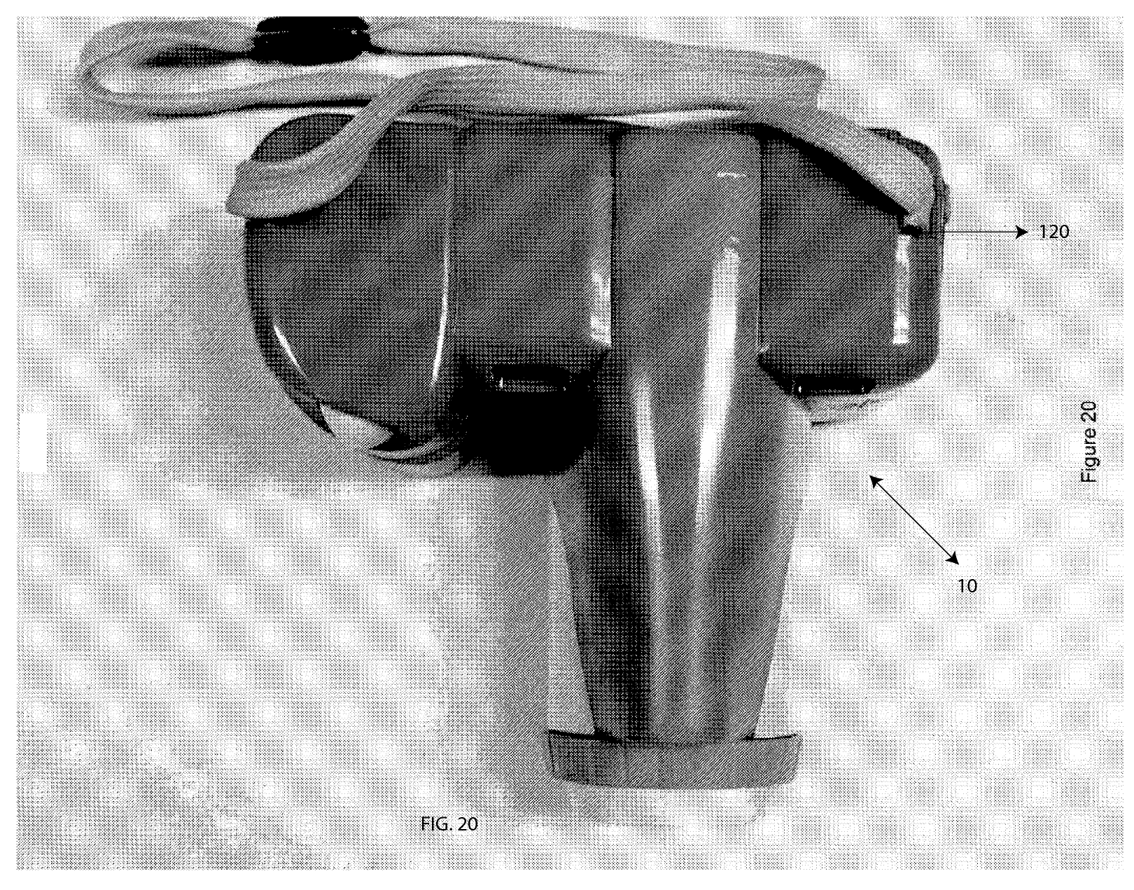

FIG. 20 is a top view of a second embodiment of the video camera and projector device. FIG. 20 shows how the device may have two strap holes 120 or connection points. This allows the user to more easily loop the strap 90 around his or her neck and balance the video camera comfortably when not in use.

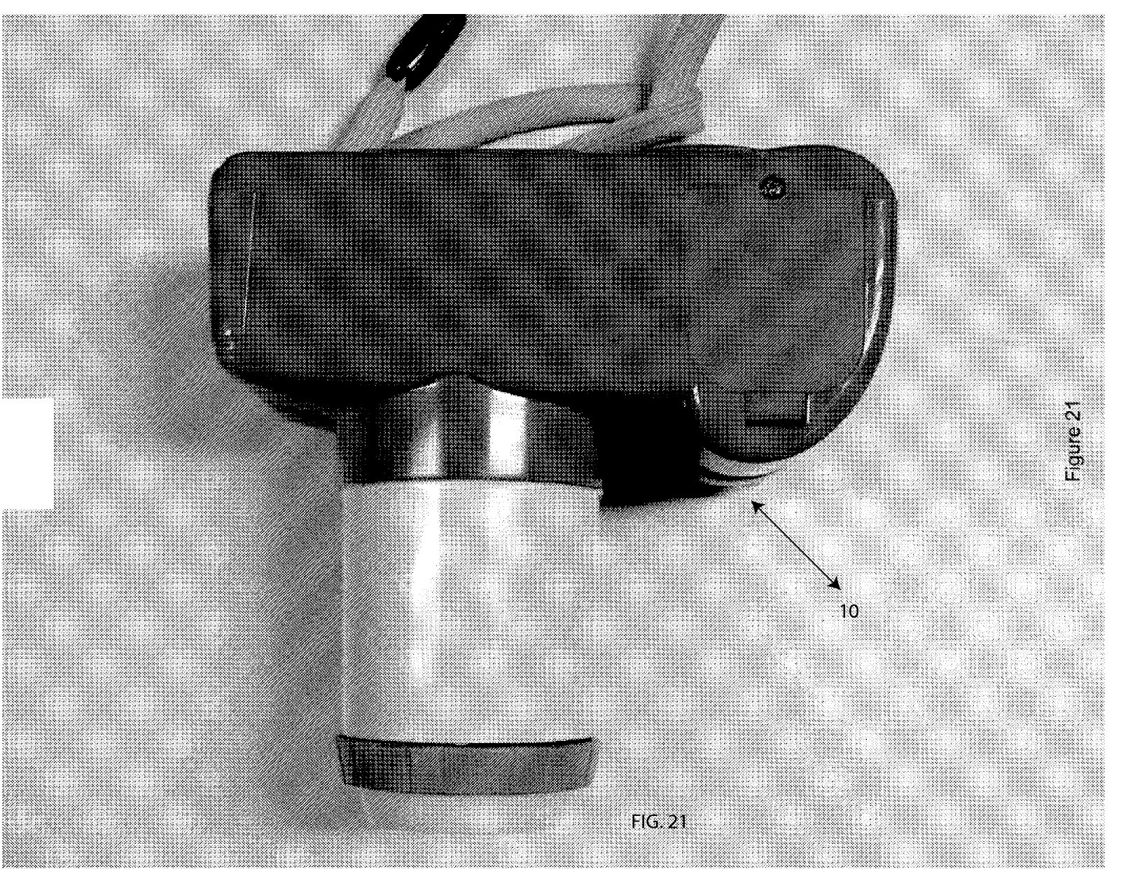

FIG. 21 is a bottom view of a second embodiment of the video camera and projector device.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description.

What is claimed is:

1. A digital video camera and projector device comprising:
a video camera; and
a projector.

2. The digital video camera and projector device of claim 1, further comprising:
a projection control panel; a video camera unit with lens, and a video camera unit and lens operation button.

3. The digital video camera and projector device of claim 2, further comprising:
a projector focus wheel.

4. The digital video camera and projector device of claim 3, further comprising:
a flash; and
a flash operation button.

5. The digital video camera and projector device of claim 3, further comprising:
a viewing screen.

6. The digital video camera and projector device of claim 3, wherein said device is designed to be used by a child.

7. The digital video camera and projector device of claim 3, wherein said device is designed to be used by a young adult.

8. The digital video camera and projector device of claim 3, wherein said projection control panel includes at least one of a power button, scrolling button, a delete button, and a project button.

9. The digital video camera and projector device of claim 8, wherein pushing said project button turns on and off the projector.

10. The digital video camera and projector device of claim 9, wherein said projector has a plurality of lenses, a projector liquid crystal display, and a light emitting diode.

11. The digital video camera and projector device of claim 10, wherein said plurality of lenses are positioned as shown in FIGS. 2 and 13 such that a brightness and a sharpness of a projected image are optimized.

12. The digital video camera and projector device of claim 11, wherein within the said digital video camera and projector device having a projector's liquid crystal display (“LCD”) thin film transistor (“TFT”) screen and bright light emitting diode (“LED”) whereby the image that is captured by the video camera is electronically sent to the projector's liquid crystal display (“LCD”) thin film transistor (“TFT”) screen and wherein the bright light emitting diode (“LED”) is positioned behind the screen to project the image.

13. The digital video camera and projector device of claim 12, wherein said lenses of the projector are stationary within the device, the device looks like a single-lens reflex video camera, with a long nose.

14. The digital video camera and projector device of claim 13, wherein said long nose provides a convenient shape and place in which to position the projection lenses.

15. The digital video camera and projector device of claim 14, wherein said video camera unit is positioned on top of the projector.

16. The digital video camera and projector device of claim 3, wherein said projector has an automatic shutoff.

17. The digital video camera and projector device of claim 15, wherein said video camera and projector device has a universal serial bus (“USB”) port.

18. The digital video camera and projector device of claim 17, wherein said video camera and projector device has an attachably attached plug or cover that covers up a universal serial bus (“USB”) port.

19. The digital video camera and projector device of claim 18, wherein said video camera and projector device has an attachably attached cover of a power unit, that is accessible through a cover, with securing screw for securing cover to video camera.

20. The digital video camera and projector device of claim 15, wherein said video camera and projector device has a slot that engages an insertable memory card, such card for use with the video camera and projector.

21. The digital video camera and projector device of claim 15, wherein said video camera and projector device has speaker holes, and a speaker behind that allow the user to play sound in the event that a video clip is being projected.
